(19) United States
(12) Patent Application Publication
(10) Pub. No.: US 2020/0364317 A1
(43) Pub. Date: Nov. 19, 2020

(54) METHOD AND SYSTEM FOR IDENTIFYING A USER TERMINAL IN ORDER TO RECEIVE STREAMING PROTECTED MULTIMEDIA CONTENT

(71) Applicant: VIACCESS, Courbevoie (FR)

(72) Inventor: Mathieu Phirmis, Antony (FR)

(21) Appl. No.: 16/957,712

(22) PCT Filed: Dec. 24, 2018
(86) PCT No.: PCT/EP2018/086857

§ 371 Date: Jun. 24, 2020

(30) Foreign Application Priority Data
Dec. 26, 2017 (FR) 17 63211

(51) Int. Cl. G06F 21/10; H04L 29/06; H04L 9/32

(52) U.S. Cl. CPC G06F 21/105; H04L 63/0457; H04L 63/0876; H04L 2463/101; H04L 9/3271; H04L 9/3236; G06F 2221/0704; H04L 63/10

(57) ABSTRACT

A method and system for identifying a user terminal, implemented within a system for provisioning multimedia content that includes a license server and a content server, the user terminal receiving multimedia content, by a digital rights management (DRM) system, that is streamed in encrypted form via an open communication network, and the user terminal retrieving, by a browser implementing a multimedia content reader and a content decryption module suitable for decrypting multimedia content that is encrypted according to the DRM system, the method including obtaining, by the license server modified to incorporate an authentication server, an identifier of the content decryption module, and generating a terminal identifier as a function of the identifier of the content decryption module.

### CROSS-REFERENCE TO RELATED APPLICATIONS

This application claims benefit under 35 USC § 371 of PCT Application No. PCT/EP2018/086857 entitled METHOD AND SYSTEM FOR IDENTIFYING A USER TERMINAL IN ORDER TO RECEIVE STREAMING PROTECTED MULTIMEDIA CONTENT, filed on Dec. 24, 2018 by inventor Mathieu Phirmis. PCT Application No. PCT/EP2018/086857 claims priority of French Patent Application No. 17 63211, filed on Dec. 26, 2017.

### FIELD OF THE INVENTION

The present invention relates to a method for identifying a user terminal in order to receive and restore protected multimedia content transmitted continuously, in encrypted form, via an open communication network, and an associated system for identifying a user terminal. It also relates to a method for authenticating a user terminal, and an associated user terminal authentication system.

If falls within the field of protecting multimedia content, in particular audiovisual content, protected by digital rights management (DRM) systems, and transmitted continuously, that is to say, according to the “streaming” transmission mode, over an open network, such as the Internet.

### BACKGROUND OF THE INVENTION

Indeed, the recent development of the “Over The Top” (OTT) technology has made it possible to generalize the streaming of multimedia content over the Internet, from conventional or dedicated servers, with an adaptive flow rate and allowing a retrieval of satisfactory quality on client devices of the personal computer type.

Several streaming protocols have been developed, for example the ISO MPEG Dynamic Adaptive Streaming over HTTP (DASH) standard, the HLS® (“HTTP LIVE STREAMING”) protocol offered by Apple®, and MSS® (“Microsoft Smooth Streaming”) offered by Microsoft®. In particular, such protocols are usable to transmit multimedia content protected by any DRM system, and to retrieve them by any web browser.

Additionally, the standardization entity W3C (World Wide Web Consortium) has developed an extension of the HTMLS standard called EME (Encrypted Media Extension), which specifies a communication channel between a web browser and the DRM agent, or content decryption module, of a DRM system.

In a known manner, a web browser, or Internet browser, or more simply browser, is HTTP client software designed to view and display data from the Internet network. Many browsers exist, for all types of user terminals (personal computer, touch-sensitive tablet, smartphone) and for different operating systems.

A CDM, or content decryption module, is a software module, also called “DRM agent”, of a user terminal, which implements, locally on this terminal, mechanisms of a DRM system in order to contribute to ensuring the legal distribution of protected content and the compliance with obligations regarding the rights holders. These mechanisms in particular use decryption means and means for verifying access rights to the content protected by this DRM system.

Several DRM systems, and corresponding DRM agents, exist, for example PlayReady®, Widevine DRM® or FairPlay®. The choice of browser determines the DRM system used. The choice of streaming protocol is at the discretion of the operator of the contents supply service, and independent of that of the browser used.

The implementation of the HTML5 EME extension allows a simplified use of DRM protection mechanisms, transparently relative to the user terminals, operating systems and browsers implemented.

Typically today, each user has several apparatuses or user terminals (smartphone, tablet, PC) that he uses in parallel. When a user wishes to access protected multimedia content, for example through a subscription to a television supply service by Internet, he wishes to be able to view this content on all of his terminals.

However, the use of the OTT content transmission service briefly described above makes it difficult to control piracy prevention of the protected multimedia content. Indeed, an application implementing HTML5 via JavaScript does not have access to the hardware resources of the user terminal, and therefore does not allow unique and lasting identification of this terminal.

As a result, it is difficult to identify a user terminal that accesses protected multimedia content, which is nevertheless a major requirement of the rights holders that any content provider must satisfy. Such an identification indeed makes it possible to improve access control to the content, in particular by prohibiting access thereto by a terminal that is anonymous or unknown by the content supply service. It can also make it possible to improve the countermeasures to the illegitimate access to the content, for example by marking the content using a watermark developed based on the identifier of the terminal used to access it.

### SUMMARY OF THE DESCRIPTION

The invention relates to a method allowing an identification of the terminal used for the consumption of protected multimedia content.

To that end, according to a first aspect, the invention proposes a method for identification, in a system for providing protected multimedia content comprising a license server and a content server, of a user terminal for receiving protected multimedia content by a digital rights management system and streamed, in encrypted form, via an open communication network, and for the retrieval, on said user terminal, by a browser implementing a multimedia content reader and a content decryption module suitable for decrypting encrypted multimedia content according to the digital rights management system. This method includes steps, carried out by the license server modified to incorporate an authentication server suitable for carrying out an authentication function, for obtaining an identifier of the content decryption module, and generating a terminal identifier as a function of the identifier of the content decryption module.

Advantageously, the method of the invention makes it possible to determine an identifier of the user terminal, in connection with an identifier of the content decryption module, or DRM agent, of the user terminal, which is a security element of the user terminal.

The user terminal identification method according to the invention may have one or more of the features below, considered independently or according to all acceptable combinations.

Obtaining an identifier of the content decryption module implements access to predetermined content, called authentication content, associated with the digital rights management system, and stored beforehand by an authentication content server, said authentication content comprising or allowing access to a rights description object associated with the digital rights management system.

The authentication content is formatted by encryption, according to said digital rights management system, of a descriptive file containing said rights description object associated with the digital rights management system.

The authentication content does not include any indication making it possible to access multimedia data.

The method comprises a step for requesting authentication content by the multimedia content reader, and a transmission of an address making it possible to access said authentication content.

The authentication content comprises said rights description object associated with the digital rights management system, accessible directly by the multimedia content reader.

The method comprises, before generating a terminal identifier, a step for receiving an authentication request containing a first element identifying the digital rights management system and a second encrypted element generated by the content decryption module, for requesting an access license to said predetermined authentication content.

The second element is a first license challenge, generated by said content decryption module from said rights description object, and cryptographically protected to allow the license server to verify the authenticity and the integrity of said first license challenge.

The method includes an extraction, as a function of said first element, of a unique element from said second element after decryption, and an allocation of the value of said unique element to the content decryption module identifier.

The method further comprises a step for sending the multimedia content reader a message including said terminal identifier and an access license to said predetermined authentication content.

The step for generating a terminal identifier includes applying a cryptographic hash function or an encryption algorithm to the identifier of the content decryption module.

The method includes steps, carried out by the multimedia content reader, for receiving a message including said terminal identifier and providing the received terminal identifier to an application for providing protected and encrypted multimedia content, said terminal identifier being stored by said application.

According to another aspect, the invention relates to a system for identifying a user terminal implemented in a system for providing protected multimedia content comprising a license server and a content server, a user terminal for receiving protected multimedia content by a digital rights management system and streamed, in encrypted form, via an open communication network, and retrieved, on said user terminal, by a browser implementing a multimedia content reader associated with a content decryption module suitable for decrypting encrypted multimedia content according to the digital rights management system. The license server is modified to incorporate an authentication server suitable for implementing an authentication module configured to obtain an identifier of said content decryption module, and to generate a terminal identifier as a function of the identifier of the content decryption module.

This identification system further includes a content authentication server.

According to another aspect, the invention relates to a method for authenticating a user terminal, in a system for providing protected multimedia content comprising a license server and a content server, the user terminal being suitable for receiving multimedia content protected by a digital rights management system and streamed, in encrypted form, via an open communication network, and said content being retrieved, on said user terminal, by a browser implementing a multimedia content reader and a content decryption module suitable for decrypting encrypted multimedia content according to the digital rights management system. This method includes, following a request to access protected multimedia content sent by said user terminal, the following steps:
generating a license request including a first identifier of the user terminal previously stored, and obtained by a terminal identification method as briefly described above, and a third encrypted element generated by the content decryption module of the user terminal, intended to request an access license to said protected multimedia content, said third element being a second license challenge cryptographically protected to allow the license server to verify the authenticity and integrity of said second license challenge,
sending said license request to said modified license server in order to incorporate an authentication server suitable for implementing an authentication function,
verifying, via said license server, the authenticity and integrity of the third encrypted element, and
in case of positive verification, obtaining a second content decryption module identifier from said third encrypted element and generating a second terminal identifier as a function of the second content decryption module identifier,
comparing the first terminal identifier with the second terminal identifier, and in case of a match, authenticating said user terminal.

According to another aspect, the invention relates to a system for authenticating a terminal implemented in a system for providing protected multimedia content comprising a license server and a content server, a user terminal for receiving protected multimedia content by a digital rights management system and streamed, in encrypted form, via an open communication network, and retrieved, on said user terminal, by a browser implementing a multimedia content reader associated with a content decryption module suitable for decrypting encrypted multimedia content according to the digital rights management system. The license server is modified in order to incorporate an authentication server suitable for implementing an authentication function, and, following a request to access protected multimedia content sent by said user terminal,
the multimedia content reader is suitable for:
generating a license request including a first identifier of the user terminal previously stored, and obtained by an identification system as briefly described above, and a third encrypted element generated by the content decryption module of the user terminal, intended to request an access license to said protected multimedia content, said third element being a second license challenge cryptographically protected to allow the license server to verify the authenticity and integrity of said second license challenge,
sending said license request to said modified license server in order to incorporate an authentication server suitable for implementing an authentication function,
   and said license server is suitable for:
verifying the authenticity and integrity of the third encrypted element, and
in case of positive verification, obtaining a second content decryption module identifier from said third encrypted element and generating a second terminal identifier as a function of said second identifier of the content decryption module,
comparing the first terminal identifier with the second terminal identifier, and in case of a match, authenticating said user terminal.

### BRIEF DESCRIPTION OF THE DRAWINGS

Other features and advantages of the invention will emerge from the description thereof provided below, for information and non-limitingly, in reference to the appended figures, in which:

FIG. 1 schematically illustrates a system for providing protected multimedia content via a DRM system in which the invention is applicable;

FIG. 2 schematically illustrates the main steps of a method for identifying a client terminal according to one embodiment of the invention;

FIG. 3 schematically illustrates the main steps of a user terminal authentication implementing a terminal identifier obtained by the method of FIG. 2.

### DETAILED DESCRIPTION

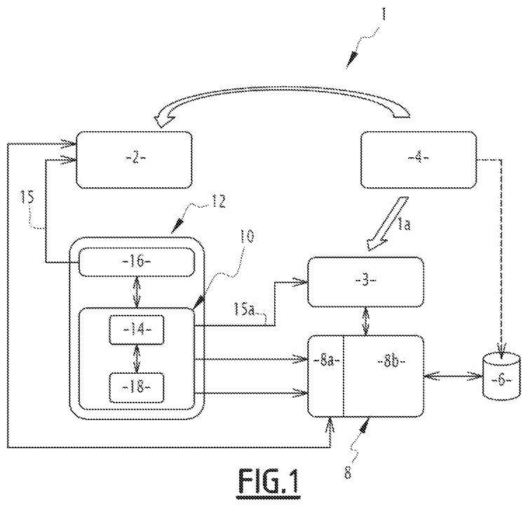

FIG. 1 schematically illustrates a system for providing multimedia content 1 in which the invention is applicable.

The supply system 1 comprises a server 2 for multimedia content protected by a DRM system, such a content server for example being managed by a content provider operator. The server 2 also implements access rights control to the content. The server 2 is for example a server of an operator providing digital television content.

Of course, the server 2 can be implemented in the form of a system of servers, comprising a server controlling access rights to protected content implemented by an operator, and content servers comprising remote multimedia data.

The supply system 1 further comprises an authentication content server 3, generated as explained in detail hereinafter.

The supply system 1 also comprises a module 4 for formatting content that makes it possible to format the content as a function of the streaming protocol, for example DASH, HLS or MSS already mentioned above, as a function of the target DRM system, and the corresponding DRM agent, for example PlayReady®, Widevine DRM® or FairPlay®.

A database 6, in relation with a license server 8, is also part of the supply system 1. The license server 8 is a known license server 8b in the DRM systems of the prior art, modified in order to incorporate an authentication server 8a suitable for implementing a terminal authentication function. The authentication server 8a for example incorporates the authentication content server 3.

In a variant, the supply system 1 comprises a terminal authentication server 8a according to the invention and a license server 8b that are separate and suitable for communicating with one another, forming an authentication and license server.

In one embodiment, the database 6 is implemented by a storage module making it possible to store a set of registrations, for example in file form.

Each of these registrations includes a content identifier C-ID formated by the module 4, and a cryptographic key. This cryptographic key is the encryption key with which the content C-ID has been encrypted for formatting, or if it is different from the preceding, the decryption key necessary to decrypt the content C-ID as it was encrypted for formatting, or a way to obtain this key. This database 6 is for example stored on the server 8 of the supply system 1.

The server 8 is configured to receive requests from a web browser 10, installed on a user terminal 12.

This web browser 10 includes a software module 14 for reading multimedia content, which implements HTML5 via JavaScript.

The terminal 12 also comprises a software module 16 that implements an application of the content supply service. In one embodiment, this application is responsible for interactions of the user and/or terminal with the content server 2, in particular to identify the user or the terminal, to control access rights of the user of the terminal, to access the content. The software module, here referred to as application of the content service, is for example a Web TV application. The access to the content is shown schematically by the arrow 15 in FIG. 1.

The content reader 14 communicates with a CDM 18 that implements, locally at this terminal 12, mechanisms of a DRM system, in particular the decryption of protected multimedia content. The implemented DRM system is determined by the web browser 10 used.

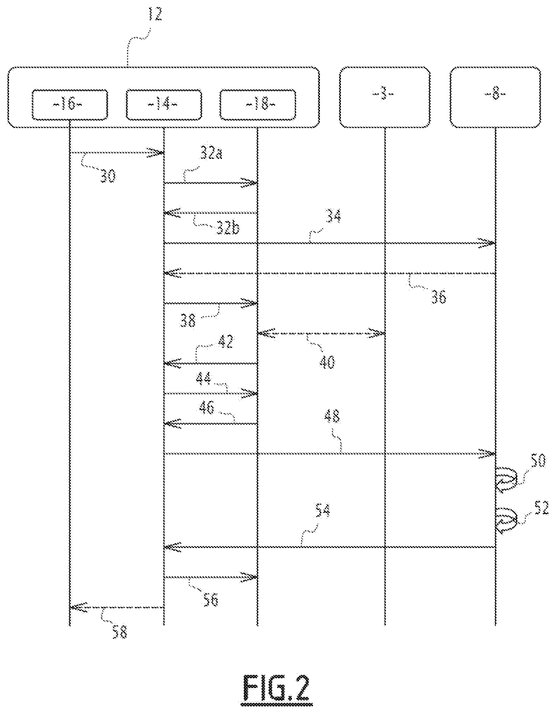

FIG. 2 schematically illustrates the main steps of a method for identifying a client terminal according to one embodiment of the invention. These steps are implemented by various elements of the content supply system 1 described above in reference to FIG. 1.

Each of the servers, as well as the user terminal, is an electronic computer that includes at least one processor suitable for executing code instructions. In a variant, the steps of the inventive method are carried out by electronic devices of the programmable logic circuit type, such as electronic boards with an FPGA or ASIC base.

During a first step 30, the application of the content service 16 sends a user terminal identification request to the multimedia content reader 14.

For example, in one embodiment, the application 16 performs this step 30 by means of an API (Application Programming Interface), for initializing the multimedia content reader 14.

After receiving the identification request of the user terminal, the content reader 14 sends CDM 18 an identification request 32a of the used DRM system. For example, the EME request requestMediaKeySystem( ) is used.

In response, in step 32b, the content reader 14 obtains a value of the parameter KeySystem that identifies the used DRM system, for example among Widevine®, PlayReady® and FairPlay®.

During step 34, the multimedia content reader 14 sends the server 8 an authentication content request. The request includes an identifier of the used DRM system, for example the form of the value of the parameter KeySystem.

The authentication content is content generated beforehand, protected with the used DRM system, and stored as content offered by the authentication content server 3, with the aim that an access request to this content triggers the identification of the terminal originating this request.

More specifically, the authentication content having been protected with the used DRM system, the request to access this authentication content causes the initialization of a DRM system, initialization on which the identification of the terminal is based, the detail of the progression of which is therefore specific to the used DRM system, and prior to the reading of the multimedia data of the content, if it includes any. Preferably, however, the authentication content does not include multimedia data.

The authentication content comprises or makes it possible to access a Right Object associated with the used DRM system. A “right object” in particular contains a header specific to the used DRM system, called PSSH (Protection System Specific Header).

For example, if it has been formatted for the DASH protocol, the authentication content is a descriptive file, also called MPD (Media Presentation Description) manifest file, which indicates a DASH initialization segment that contains a specific header, referred to as “Protection System Specific Header” (PSSH). The authentication content is next encrypted according to the ISO Common Encryption (CENC) standard, for example with the Widevine® technology.

Similarly, if it has been formatted for the MSS protocol, the authentication content is for example a descriptive file of the ISMC manifest type, which is next encrypted according to the CENC standard, for example with the PlayReady® technology.

Similarly, if it has been formatted for the HLS protocol, the authentication content is for example a descriptive file of the M3U8 playlist type, which is next encrypted according to the CENC standard, for example with the FairPlay® technology.

In each of these examples, the descriptive file of the authentication content includes, in a known manner for all of the content, a right object necessary to initialize a DRM section in order to lift the protection of this content. The right object contains an identifier of the DRM system with which the content is protected (KeySystem) and information making it possible to obtain the decryption key of the content.

In each of these examples, in general, for a given content, the descriptive file of the content further contains at least one URL indicating multimedia data of this content.

Here, preferably, the authentication content does not include multimedia data, and its descriptive file, unlike a descriptive file for any content, does not include a URL indicating multimedia data.

According to one embodiment, an authentication content by covered DRM system is formatted by module 4, then stored in the server 3. Each authentication content is accessible by means of a URL (Uniform Resource Locator) address. The encryption key as well as an identifier of the associated DRM system are stored in combination with the URL of each authentication content.

According to another variant, the authentication content for the used DRM system is generated and stored after receiving the request 34.

According to another variant, several authentication contents for at least one DRM system are generated and stored, for example authentication contents also including multimedia data.

In response to the authentication content request, the URL address by means of which it is accessible is sent to the multimedia content reader 14 during step 36.

According to another embodiment, the content reader 14 has access directly to a right object associated with the used DRM system. In this embodiment, steps 34 and 36 are processed locally, without exchange with server 8. In this case, the authentication content is formed by the right object that is directly accessible, and the authentication content server 3 is integrated into the terminal 12.

Following receipt of the authentication content, the multimedia content reader 14 initializes (step 38) a DRM session to read the received authentication content corresponding to the used DRM system, according to the EME standard. After this initialization, the multimedia data of the authentication content, if it includes any, are streamed in step 40, similarly to any streaming of multimedia data of multimedia content.

The authentication content being protected by encryption, an access license according to the used DRM system is necessary, in particular including a decryption key.

During step 42, the CDM 18 then sends a request to the content reader 14 in order to obtain a decryption key for the authentication content.

Upon receiving the request in step 42, the content reader 14 asks the CDM 18, in step 44, to generate a license challenge based on the right object obtained from the authentication content.

A license challenge refers to a data block generated by the CDM from the right object in order to obtain the license including the decryption key for the content. The generated license challenge can include an identifier CDM-ID of the CDM. In this case, the identifier CDM-ID is more specifically an identifier of the CDM instance initialized in the considered terminal, inserted by the CDM itself in the license challenge. The license challenge is cryptographically protected in authenticity and integrity, such that a license server can later verify its authenticity as well as its integrity.

In step 46, the CDM 18 returns an encrypted license challenge to the content reader 14.

In the following step 48, the content reader 14 generates and sends the server 8 an authentication request, containing a first element identifying the used DRM system and a second encrypted element generated by the CDM module 18. For example, the first element is the value of the parameter KeySystem that identifies the used DRM system, and the second element is the encrypted license challenge supplied by the CDM 18.

In a variant, the first element of the authentication request is a URL address associated with the used DRM system.

The authentication request is received by the license server 8.

The server 8b of the server 8 implements a step 50 during which it extracts the license challenge from the received request, verifies the authenticity and the integrity of the license challenge, and generates the license required to read the authentication content. The license in particular contains the decryption key to be used in order to decrypt the authentication content.

During the same step 50, when the license challenge includes an identifier CDM-ID of the CDM, the license server 8b of the server 8 extracts it according to a scheme specific to the used DRM system and sends it to the authentication server 8a.

For example, when the DRM agent is PlayReady®, the public key of the decryption module sent in the license challenge is taken as identifier CDM-ID. In a variant, any other unique element sent in the license challenge can be used as identifier.

For example, when the DRM agent is FairPlay®, the identifier CDM-ID assumes the value of the parameter HU of the SPC (Server Playback Context) challenge.

When the license challenge does not include an identifier CDM-ID of the CDM, such an identifier is generated, stored, inserted in the license and sent to the authentication server 8a, by the license server 8b. For example, when the DRM agent is Widevine, the identifier CDM-ID assumes the value of the PCT (Provider Client Token) parameter. This identifier is generated by using a pseudo-random generator.

Thus, the identifier CDM-ID is a unique element extracted from the license challenge after decryption.

In step 52, the authentication server 8a of the server 8 next generates a terminal identifier, denoted T-ID, from the identifier CDM-ID.

In one embodiment, the terminal identifier is generated by applying a cryptographic hash function, for example HMAC-SHA256, to the decryption module identifier CDM-ID:

TID=HMAC-SHA256(CDM-ID, Ks)

Where Ks is a secret key.

In a variant, any other encryption algorithm applied to the identifier CDM-ID is applicable.

A response containing the generated license and the terminal identifier T-ID is sent to the content reader 14 in step 54, which sends the received license to the CDM 18 in step 56.

Lastly, the content reader 14 extracts the terminal identifier T-ID thus obtained, stores it, and sends it to the software module 16 in step 58. The terminal identifier is stored by the application of the content service.

Advantageously, the terminal identifier T-ID thus generated is unique for a physical user terminal and a given web browser, since it is generated from a unique identifier associated with the CDM initialized in the terminal according to the used DRM system. In principle, for any DRM system, the CDM originating a license challenge is identified uniquely.

The persistence of the identifier T-ID is related to the persistence of the data of the CDM as managed by the browser. More specifically, their lifetimes are the same.

It is next possible to verify, at any moment, the authenticity of a user terminal identifier T-ID thus obtained and stored.

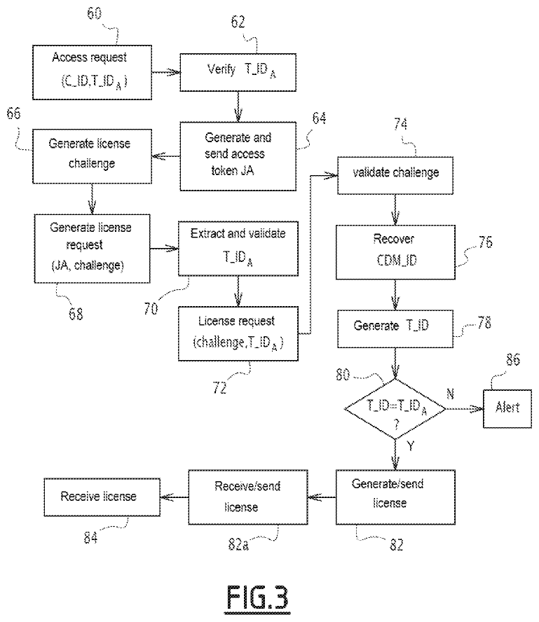

FIG. 3 schematically illustrates the main steps of a user terminal authentication method using a terminal identifier previously obtained using the identification method described above.

The content reader 14 has previously recorded a terminal identifier T-ID_{A}, which is also recorded by the content provider operator.

In order to read the new multimedia content, the content provider 14 generates an access request 60 that includes a content identifier C-ID and the terminal identifier T-ID_{A} previously recorded.

The access request 60 is sent to the server 2, which implements an access rights check. In step 62, the server verifies that the terminal identified by T-ID_{A} has previously been registered, and in case of positive verification, next verifies the right of the terminal T-ID_{A} to access the content C-ID. Next, only if this second verification is successful, an access token to the content identified by C-ID is sent to the content reader in step 64. The access token includes the terminal identifier T-ID_{A}, and is cryptographically protected in authenticity and integrity, such that a content server can later verify its authenticity as well as its integrity.

In step 66, the content reader is then able to generate a license challenge as already described above, and a license request containing the generated license challenge and the access token in step 68.

Upon receiving this license request, the server 2 verifies the authenticity and the integrity of the access token, and in case of positive verification, extracts the identifier of the terminal T-ID_{A} therefrom (step 70).

The server 2 next sends (step 72) the license 8 a license request containing the license challenge and the identifier of the terminal T-ID_{A}.

The license server 8b of the server 8 verifies the authenticity and the integrity of the license challenge received in step 74 and, in case of positive verification, extracts a CDM identifier, CDM-ID, therefrom in step 76. The implementation of step 76 is similar to the implementation of step 50 described in reference to FIG. 2.

Similarly to step 52, a terminal identifier T-ID is generated by the authentication server 8a of the server 8 in step 78 from the decryption module identifier CDM-ID.

Next, in step 80, the computed identifier T-ID is compared to the received terminal identifier T-ID_{A}.

In case of match, the terminal is authenticated successfully, and step 80 is followed by a step 82 for generating and sending a license containing the decryption key for the encrypted multimedia content identified by C-ID. The license is sent to the server 2, which sends it (step 82a) to the multimedia content reader.

In case of mismatch during the comparison done in step 80, an alarm is for example generated (step 86) and sent to the content service, and the license is not sent, which results in preventing the reading of the multimedia content identified by C-ID by the content reader 14 of the user terminal 12.

1. A method comprising:
identifying, within an open communication multimedia content provisioning network that includes a license server and a content server, a user terminal for (i) receiving multimedia content protected by a digital rights management system and streamed, in encrypted form via the network, and (ii) for retrieving the streamed multimedia content, by a browser implementing a multimedia content reader and a content decryption module that decrypts multimedia content that was encrypted according to the digital rights management system, the method comprising:
obtaining, by an authentication server that is incorporated within the license server, an identifier of the content decryption module; and
generating, by the authentication server, a user terminal identifier as a function of the identifier of the content decryption module.

2. The method according to claim 1, wherein said obtaining comprises accessing predetermined authentication content, associated with the digital rights management system, and stored beforehand by a content authentication server the authentication content comprising or allowing access to a rights description object associated with the digital rights management system.

3. The method according to claim 2, wherein the authentication content is generated by encrypting, according to the digital rights management system, a descriptive file containing the rights description object.

4. The method according to claim 3, wherein the authentication content does not include any indication making it possible to access the multimedia content.

5. The method according to claim 2, further comprising requesting the authentication content by the multimedia content reader, and transmitting an address that enables access to the authentication content.

6. The method according to claim 2, wherein the authentication content comprises the rights description object associated with the digital rights management system, accessible directly by the multimedia content reader.

7. The method according to claim 2, comprising, prior to said generating, receiving an authentication request containing a first element identifying the digital rights management system and a second encrypted element generated by the content decryption module, for requesting a license to access the authentication content.

8. The method according to claim 7, wherein the second encrypted element is a first license challenge, generated by the content decryption module from the rights description object, and cryptographically protected to allow the license server to verify the authenticity and the integrity of the first license challenge.

9. The method according to claim 7, further comprising:
extracting, as a function of the first element, a unique element from the second element decryption; and
allocating the value of the unique element to the content decryption module identifier.

10. The method according to claim 9, further comprising sending to the multimedia content reader a message comprising the user terminal identifier and a license to access the authentication content.

11. The method according to claim 1, wherein said generating comprises applying a cryptographic hash function or an encryption algorithm to the identifier of the content decryption module.

12. The method according to claim 1, further comprising:
receiving, by the multimedia content reader, a message including the user terminal identifier; and
providing, by the multimedia content reader, the received user terminal identifier to an application for providing protected and encrypted multimedia content, the user terminal identifier being stored by the application.

13. A method comprising authenticating a user terminal, within an open communication network for provisioning multimedia content the network including a license server and a content server, the authenticating comprising:
providing multimedia content to a user terminal, the multimedia content being protected by a digital rights management system, and the multimedia content being streamed, in encrypted form via the network; and
retrieving the multimedia content, on the user terminal, by a browser implementing a multimedia content reader and a content decryption module that decrypts multimedia content that was encrypted according to the digital rights management system; and
in response to a request, sent by the user terminal, to access the multimedia content:
generating a license request including (i) a first identifier of the user terminal previously stored, and obtained by the method according to claim 8, and (ii) a third encrypted element generated by the content decryption module of the user terminal for requesting a license to access the multimedia content, the third encrypted element being a second license challenge cryptographically protected to allow an authentication server, incorporated within the license server, to verify the authenticity and integrity of the second license challenge;
sending the license request to the authentication server;
verifying, via the authentication server, the authenticity and integrity of the third encrypted element; and
in case of positive verification,
obtaining a second content decryption module identifier from the third encrypted element and generating a second identifier of the user terminal as a function of the second content decryption module identifier; and
comparing the first and second identifiers of the user terminal and in case of a match, authenticating the user terminal.

14. A system for identifying a user terminal implemented within an open communication network for provisioning multimedia content, the network including a license server, a content server, and a user terminal (i) receiving multimedia content that is protected by a digital rights management system and that is streamed in encrypted form via the network, and (ii) retrieving the multimedia content, by a browser implementing a multimedia content reader associated with a content decryption module that decrypts multimedia content that was encrypted according to the digital rights management system, the system comprising an authentication server incorporated within the license server and configured to obtain an identifier of the content decryption module, and to generate a user terminal identifier as a function of the identifier of the content decryption module.

15. The system according to claim 14, further comprising a content authentication server.

16. A system for identifying a user terminal, the system implemented within an open communication network for provisioning multimedia content, the network including a license server, a content server, and a user terminal that receives multimedia content that is protected by a digital rights management system, that is streamed in encrypted form via the network, and that is retrieved, on the user terminal, by a browser implementing a multimedia content reader associated with a content decryption module that decrypts multimedia content that was encrypted according to the digital rights management system, the system comprising an authentication server that is incorporated within the license server,
wherein, in response to a request sent by the user terminal to access the multimedia content,
the multimedia content reader generates a license request including (i) a first identifier of the user terminal previously stored, and obtained by the method according to claim 8, and (ii) a third encrypted element generated by the content decryption module of the user terminal, the third element comprising a second license challenge cryptographically protected to allow said authentication server to verify the authenticity and integrity of the second license challenge,
the user terminal sends the license request to said authentication server, and
said authentication server:
verifies the authenticity and integrity of the third encrypted element, and
in case of positive verification,
obtains a second identifier of the content decryption module from the third encrypted element and generates a second identifier of the user terminal as a function of the second identifier of the content decryption module, and
compares the first and second identifiers of the user terminal, and in case of a match, authenticates the user terminal.
